(19) United States
(12) Patent Application Publication
(10) Pub. No.: US 2006/0029919 A1
(43) Pub. Date: Feb. 9, 2006

(54) Educational game hoop

(76) Inventor: Larry Anderson, Taylors, SC (US)

Correspondence Address: LARRY ANDERSON, 208 Dellrose Circle, Taylors, SC, 29687, US

(21) Appl. No.: 11/249,923

(22) Filed: Oct. 14, 2005

Related U.S. Application Data
(63) Continuation-in-part of application No. 10/832,508, filed on Apr. 27, 2004.

(51) Int. Cl. G09B 3/00

(52) U.S. Cl. 434/322

(57) ABSTRACT

An educational game hoop having a plurality of questions and corresponding answers on the hoop surface. The game hoop may include a plurality of light emitting diodes carried on at least one hoop surface corresponding to a question and its corresponding answer. A control system may be in communication with the plurality of light emitting diodes and may be voice activated to reproduce sound including speech.

### CROSS REFERENCE TO RELATED APPLICATION

This application is a continuation-in-part of prior application Ser. No. 10/832,508 filed Apr. 27, 2004, which is hereby incorporated by reference.

### BACKGROUND

The present invention is related to educational game toys, and in particular to educational game toy hoops that are rotated about the body, waist, neck or arms.

Hoop toys that are rolled or spun about the body, waist, neck or arms are well known in the art. U.S. Pat. No. 3,079,728 represents the archetype of a hoop toy that may be spun about the body. Variations of this archetype have emerged since, such as musical hoop toys, lighted hoop toys, segmented hoop toys, decorative cloth covered hoop toys, water filled hoop toys, and water emitting hoop toys.

### SUMMARY

The drawings illustrate an educational game hoop having a continuous upper surface, lower surface, inner surface, and outer surface. The educational game hoop may be rotated about the body, waist, neck, or arms of a player or rolled or spun on the ground by a player. The educational game hoop has a plurality of questions and corresponding answers on the hoop surface. The plurality of questions are preferably on at least one hoop surface and the plurality of corresponding answers are preferably on at least one other hoop surface.

The game hoop may further include a plurality of light emitting diodes carried on at least one hoop surface. The light emitting diodes may correspond to a question and its corresponding answer. A control system may be in communication with the plurality of light emitting diodes. The control system may be voice activated.

In yet another embodiment the a educational game hoop may include a talking hoop component with a sound synthesizer, a memory operably coupled with the synthesizer and containing at least some speech data, and a speaker operably coupled with the synthesizer to reproduce sound including speech and a power source. A plurality of questions forming at least some of the speech data may be carried by the memory. A voice activated control system may be in communication with the talking hoop component.

### BRIEF DESCRIPTION OF THE DRAWINGS

FIG. 1 is a perspective view illustrating the rotation around the body of an educational game hoop constructed in accordance with the invention;

FIG. 2a is an elevational view illustrating a question provided on a surface of an educational game hoop constructed in accordance with the present invention;

FIG. 2b is an elevational view illustrating a corresponding answer to the question of FIG. 2a, provided on another surface of an educational game hoop constructed in accordance with the invention; and

FIG. 3 is a cross-sectional view illustrating an educational game hoop constructed in accordance with the invention; and

FIG. 4 is a schematic block diagram illustrating an educational game hoop constructed in accordance with the invention.

### DETAILED DESCRIPTION

The present invention relates to embodiments for an educational game hoop 10 that may be rotated about the body, waist, neck, or arms of a player or rolled or spun on the ground by a player. The educational game hoop 10 has a plurality of questions 20 and corresponding answers 22 on the hoop surface. The hoop may further include a plurality of light emitting diodes 24 and a talking hoop component 28.

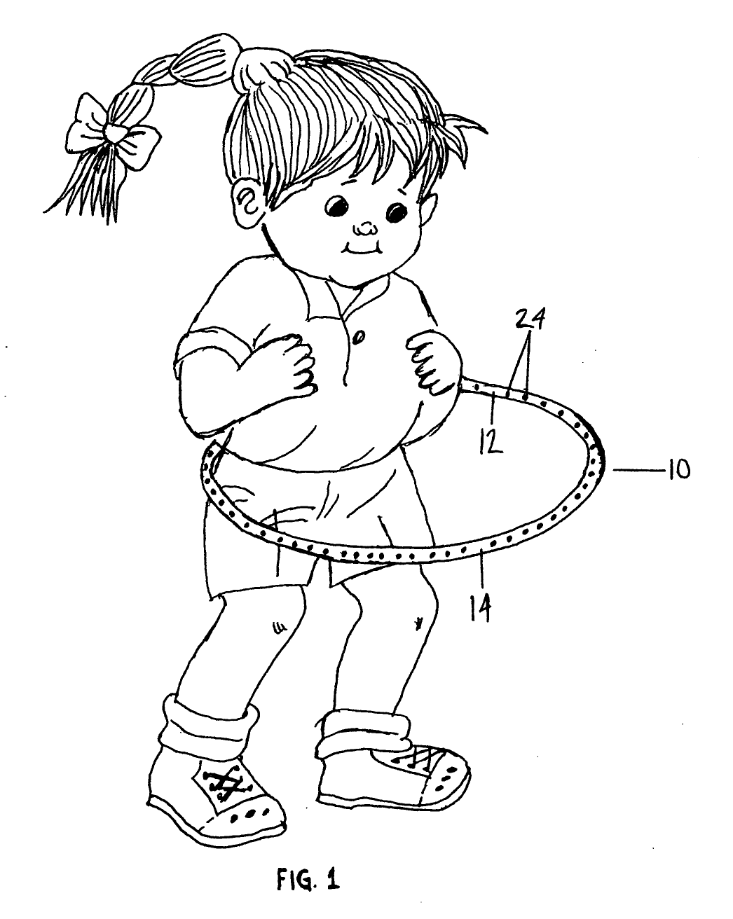

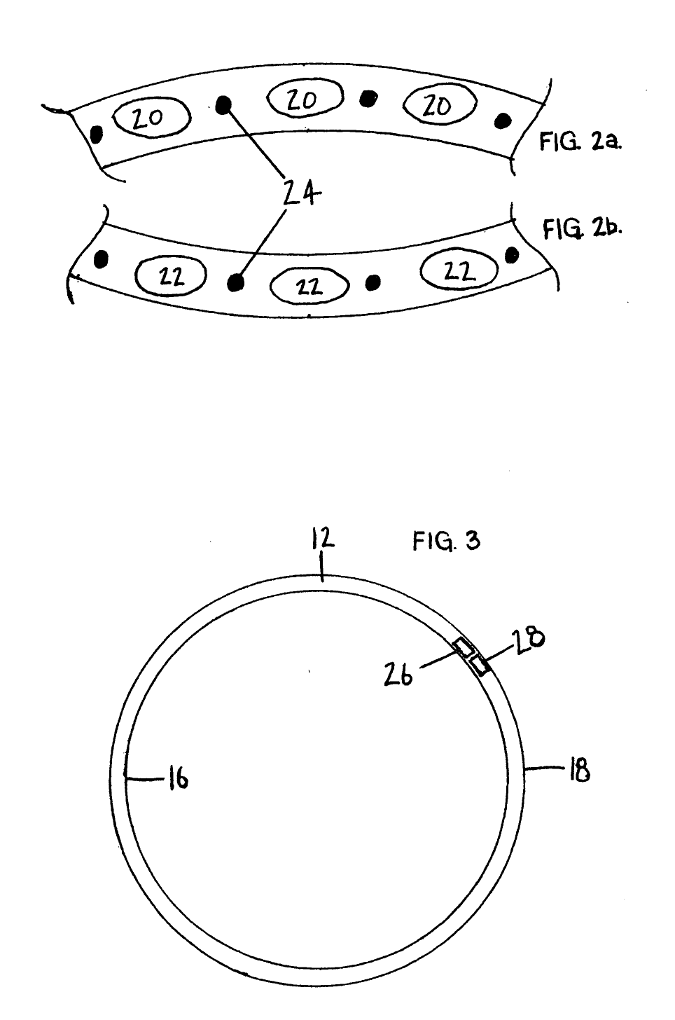

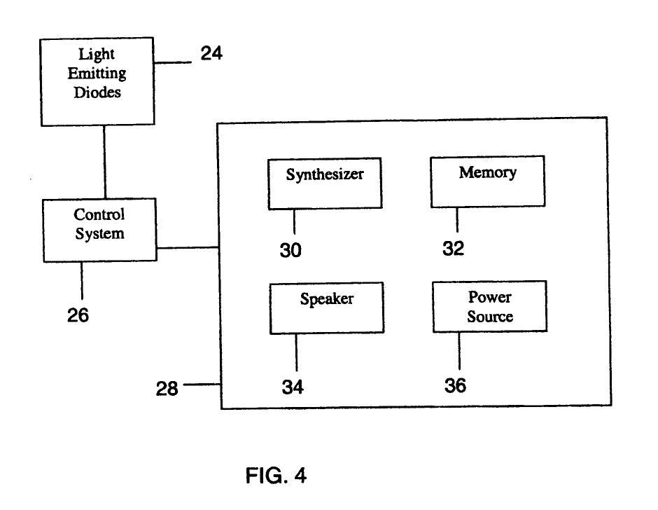

One embodiment of the educational game hoop, generally indicated at 10, is shown in FIG. 1. The hoop 10 has a continuous upper surface 12, lower surface 14, inner surface 16, and outer surface 18. The hoop 10 may be constructed from elastically flexible plastic materials such as extruded polyethylene (PE), polyethylene terephthalate (PET, PETE), polyethylene terephthalate glycol (PETG), polyvinyl chloride (PVC), high density polyethylene (HDPE), polypropylene (PP), polystyrene (PS), or other thermoplastic polyesters. Additional construction materials known in the art such as aluminum or wood may also be used.

The hoop 10 has a plurality of questions 20 and corresponding answers 22 disposed on the hoop surface. In this embodiment, the plurality of questions 20 are disposed on at least one hoop surface and the plurality of corresponding answers 22 are disposed on at least one other hoop surface. In one embodiment, the questions 20 and corresponding answers 22 may be applied to the hoop surfaces 12, 14, 16, 18 via painting, printing, or adhesion.

The educational game hoop 10 may further include a plurality of light emitting diodes 24 disposed on at least one hoop surface 12, 14, 16, 18. The light emitting diodes 24 may correspond to a question 20 and/or its corresponding answer 22. A control system 26 is in communication with and controls the activation of the light emitting diodes 24. In one embodiment, the control system 26 may be voice activated.

A talking hoop component 28 including a sound synthesizer 30, a memory 32, a speaker 34, and a power source 36 may be placed in communication with the control system 26. Memory 32 operably couples with the synthesizer 30 and contains at least some speech data. A plurality of questions and corresponding answers may form at least some of the speech data carried by the memory 32. The speaker 34 couples with the synthesizer to reproduce sound, including the memory's 32 speech data. In one embodiment, the memory 32 is removable and replaceable.

In one manner of use, the educational game hoop 10 may be placed around the body, waist, arm, or neck of a player and rotated thereabout. In one embodiment, the player stops the rotation by grasping the hoop 10 with the player's hand. Upon discontinuance of rotation, the control system 26 activates a light emitting diode 24 on the hoop surface 12, 14, 16, 18. The activated light emitting diode 24 determines the question 20 provided on the hoop surface 12, 14, 16, 18 the player is to answer. The player's answer to the question is then verified against the corresponding answer 22 provided on another hoop surface 12, 14, 16, 18. Points are scored by answering the questions correctly and may be tallied to determine a “winner.”

In another manner of use, the player may also simultaneously with grasping the hoop 10, or nearly so, speak aloud a “stop” command. Upon the manual discontinuance of the rotation, or upon the voice command from the player, the control system 26 may cue talking hoop component 28 to access memory 32. The talking hoop component cues the transfer of selected speech data carried by the memory 32 to the sound synthesizer 30. Together, memory 32 and synthesizer 30 read the question 20 (and/or the corresponding answer 22) to the player by reproducing and outputting the speech data via a speaker 34.

The pluralities of questions 20 and pluralities of corresponding answers 22 to be provided on the educational hoop surface or carried by memory 32 may comprise a variety of subject matter and differing levels of difficulty, such that children of all education levels and ability may have specific educational game hoops or questions and corresponding answers targeted to their skill and ability level across a range of subjects. While the following subjects are not exhaustive, they are intended to be indicative of the subject matter contemplated for the pluralities of questions 20 and corresponding answers 22 to be provided on the hoop surface: Mathematics, English, Spelling, History, Science, Language, Foreign Language, Geography, Art, Music, Trivia, Color Recognition, Shape Recognition, Sports Recognition, Sports Trivia, Synonyms, and other educational subject matter.

The pluralities of questions 20 and corresponding answers 22 have been described as being applied to the hoop surfaces 12, 14, 16, 18 via painting, printing, or adhesion, however this is not required. In one embodiment the questions 20 and corresponding answers 22 may be removably secured to the surface of the educational game hoop 10 via hook and loop fastener elements. In this embodiment one fastener element is applied to the hoop surface (hook or loop fastener element) and the corresponding fastener element is removably applied to, or comprises, the pluralities of questions 20 and pluralities of corresponding answers 22 (loop or hook fastener elements, respectively.) In another embodiment, the questions 20 and corresponding answers 22 may be painted, printed, stitched, knitted, woven or adhered onto a fabric sleeve, which may then be placed over and secured to the hoop.

The educational game hoop has been described as presenting the question first, however this is not required. In one embodiment, the player is first presented with the answer 22 and must correctly translate or respond with the corresponding question 20.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. An educational game hoop device, comprising:
a closed hoop having continuous upper and lower, and inner and outer surfaces;
a plurality of questions on at least one hoop surface;
a plurality of corresponding answers on at least one other hoop surface;
a plurality of light emitting diodes carried on at least one hoop surface, the light emitting diodes corresponding to a question and its corresponding answer; and
a control system in communication with the plurality of light emitting diodes.

2. The device of claim 1 wherein the pluralities of questions and corresponding answers are removably securable to the hoop surfaces.

3. The device of claim 1 wherein the control system sequentially activates the light emitting diodes.

4. The device of claim 1 wherein the control system randomly activates the light emitting diodes.

5. The device of claim 1 wherein the control system is voice activated.

6. The device of claim 1 wherein the pluralities of questions and corresponding answers are selected from the group consisting of: Mathematics, English, Spelling, History, Science, Language, Foreign Language, Geography, Art, Music, Trivia, Color Recognition, Shape Recognition, Sports Recognition, Sports Trivia, Synonyms, or other educational subject matter.

7. An educational game hoop device, comprising:
a closed hoop having continuous upper and lower, and inner and outer surfaces;
a talking hoop component including a sound synthesizer, a memory operably coupled with the synthesizer and containing at least some speech data, a speaker operably coupled with the synthesizer to reproduce sound including speech, and a power source;
a plurality of questions forming at least some of the speech data carried by the memory; and
a voice activated control system in communication with the talking hoop component.

8. The device of claim 7 wherein the control system randomly accesses the speech data stored on the memory.

9. The device of claim 7 wherein the game hoop further includes a plurality of light emitting diodes carried on at least one hoop surface, the light emitting diodes corresponding to a question and its corresponding answer.

10. The device of claim 9 wherein the control system is in communication with the plurality of light emitting diodes.

11. The device of claim 10 wherein the control system sequentially activates the light emitting diodes.

12. The device of claim 10 wherein the control system randomly activates the light emitting diodes.

13. The device of claim 7 wherein the memory is removable.

14. The device of claim 7 wherein the pluralities of questions and corresponding answers are selected from the group consisting of: Mathematics, English, Spelling, History, Science, Language, Foreign Language, Geography, Art, Music, Trivia, Color Recognition, Shape Recognition, Sports Recognition, Sports Trivia, Synonyms, or other educational subject matter.

15. An educational game hoop device, comprising:
a closed hoop having continuous upper and lower, and inner and outer surfaces;
a plurality of questions on at least one hoop surface;
a plurality of corresponding answers on at least one other hoop surface
a plurality of light emitting diodes carried on at least one hoop surface, the light emitting diodes corresponding to a question and its corresponding answer;
a talking hoop component including a sound synthesizer, a memory operably coupled with the synthesizer and containing at least some speech data, a speaker operably coupled with the synthesizer to reproduce sound including speech, and a power source;
a plurality of questions forming at least some of the speech data carried by the memory; and
a voice activated control system in communication with the plurality of light emitting diodes and the talking hoop component.

16. The device of claim 15 wherein the control system sequentially activates the light emitting diodes.

17. The device of claim 15 wherein the control system randomly activates the light emitting diodes.

18. The device of claim 15 wherein the control system randomly accesses the speech data stored on the memory.

19. The device of claim 15 wherein the memory is removable.

20. The device of claim 15 wherein the pluralities of questions and corresponding answers are selected from the group consisting of: Mathematics, English, Spelling, History, Science, Language, Foreign Language, Geography, Art, Music, Trivia, Color Recognition, Shape Recognition, Sports Recognition, Sports Trivia, Synonyms, or other educational subject matter.
